(19) United States
(12) Patent Application Publication
(10) Pub. No.: US 2019/0056550 A1
(43) Pub. Date: Feb. 21, 2019

(54) SURFACE PROCESSING DEVICE FOR LIGHT GUIDE PLATE AND LIGHT GUIDE PLATE MADE THEREBY

(71) Applicant: TALANT OPTRONICS (SUZHOU) CO., LTD, Suzhou City (CN)

(72) Inventors: Jian WANG, Suzhou City (CN); Shuiyin WANG, Suzhou City (CN)

(73) Assignee: TALANT OPTRONICS (SUZHOU) CO., LTD, Suzhou City (CN)

(21) Appl. No.: 15/686,693

(22) Filed: Aug. 25, 2017

(30) Foreign Application Priority Data
Aug. 18, 2017 (CN) 201710712330.7

(51) Int. Cl. G02B 6/122

(52) U.S. Cl. CPC G02B 6/122; G02B 2006/12166

(57) ABSTRACT

A surface machining device for a light guide plate is disclosed, including: a support 11; a driving component 12 mounted on the support 11; a push unit 13 driven by the driving component 12, configured to push the light guide plate 10 to a pre-set position; a positioning component 14 driven by the driving component 12, configured to position the light guide plate 10 at the pre-set position; a bearing component 15 mounted on the support 11, configured to bear the light guide plate 10; and a pressing component 16 driven by the driving component 12, configured to press the light guide plate 10 onto the bearing component 15. With such device, an ultrathin light guide plate 10 can be machined to form a microstructure on the surface of the light guide plate 10, with high productivity, and low cost.

### FIELD

The present disclosure relates to the field of lighting, and more particularly, to a light guide plate in an LED.

### BACKGROUND

The design of a light guide plate originates from a liquid crystal display screen of a notebook computer. A light guide plate may transform a line light source into an area light source. The light guide plate takes an optical grade acrylic (PMMA)/PC as a substrate. Light enters the light guide plate from an incident surface of the light guide plate, and scatters at netted dots on the light guide plate so that the light is uniformly distributed. The microstructure design of the incident surface of the light guide plate, that is, the surface of the light guide plate, can improve the optical performance of the light guide plate.

In the process of realizing the traditional technology, the inventor found out the following technical problems.

At present, the only way to manufacture light guide plate with a surface microstructure in the industry is injection molding. Due to the requirement of a size of an ultrathin light guide plate, the production efficiency of the light guide plate by injection molding is relatively low. Moreover, both a professional injection molding machine and a precision mould are required, which lead to a very high production cost. Thus, there is a need to provide a technical solution with relatively high productivity and relatively low cost.

### SUMMARY

Based on the above, it is necessary to provide a solution to the technical problem that the production efficiency is relatively low and the production cost is relatively high in manufacturing the above-mentioned light guide plate.

A surface machining device for a light guide plate is provided, including:

a support;

a driving component mounted on the support;

a push unit driven by the driving component, configured to push the light guide plate to a pre-set position;

a positioning component driven by the driving component, configured to position the light guide plate at the pre-set position;

a bearing component mounted on the support, configured to bear the light guide plate; and

a pressing component driven by the driving component, configured to press the light guide plate onto the bearing component.

In one embodiment, the driving component includes a cylinder.

In one embodiment, the push unit includes a push rod assembly configured to push the light guide plate to the pre-set position in a feed direction of the light guide plate.

In one embodiment, the positioning component includes a positioning column;

the positioning column is adapted to abut against a surface to be machined of the light guide plate, when the positioning column is in a positioning state driven by the driving component; and

the positioning column is adapted to retreat to expose the surface to be machined of the light guide plate, when the positioning column is in a release state driven by the driving component.

In one embodiment, the surface machining device is further provided with a guide rail, so as to adjust the positioning component to be parallel to the surface to be machined of the light guide plate, and to adjust the push unit to be parallel to another surface of the light guide plate opposite to the surface to be machined.

The present disclosure further provides another surface machining device for a light guide plate, including:

a working head configured to machine a surface of the light guide plate;

a clamping component configured to clamp the working head;

a first horizontal seat slidably connected to the clamping component to allow the working head to translate in a first direction; and

a second horizontal seat slidably connected to the first horizontal seat to allow the working head to translate in a second direction perpendicular to the first direction.

In one embodiment, a clamping seat is provided between the clamping component and the first horizontal seat;

the clamping component is translatable in the first direction with respect to the clamping seat; and

the clamping seat is translatable in the first direction with respect to the first horizontal seat.

In one embodiment, an elastic element is provided between the clamping component and the clamping seat, to provide a pre-set machining pressure during machining for the surface of the light guide plate.

In one embodiment, the clamping seat is translatable in the second direction with respect to the second horizontal seat.

In one embodiment, the surface machining device is further provided with a temperature control assembly configured to heat the working head.

The present disclosure further provides a light guide plate. The light guide plate is manufactured by the surface machining device of any one of claims 1-5 cooperated with the surface machining device of any one of claims 6-10.

In one embodiment, at least one surface of the light guide plate is formed with a plurality of serrated grooves, each serrate groove having an opening angle of 40° to 119°.

In one embodiment, there is a transition fillet between adjacent two serrated grooves, with a radius in a range between 6 μm and 38 μm.

In one embodiment, there is a transition fillet arranged at the bottom of each serrated groove, with a radius in a range between 1 μm and 38 μm.

In one embodiment, each serrated groove spans a distance in a range between 20 μm and 300 μm.

The present disclosure has at least the following technical effects.

Before machining a surface of a light guide plate, a bearing component mounted on a support can be configured to bear the light guide plate, a pressing component driven by a driving component can be configured to press the light guide plate onto the bearing component, so a ultrathin light guide plate can be machined to form a microstructure on the surface of the light guide plate, with high productivity and low cost.

### BRIEF DESCRIPTION OF THE DRAWINGS

FIG. 1 is a front view of a surface machining device for a light guide plate according to one embodiment of the present disclosure.

FIG. 2 is a left view of the surface machining device for the light guide plate of FIG. 1.

FIG. 3 is another schematic view of the surface machining device for the light guide plate of FIG. 1.

FIG. 4 is a front view of a surface machining device for a light guide plate according to another embodiment of the present disclosure.

FIG. 5 is a schematic diagram illustrating two cooperated surface machining devices machining a light guide plate according to one embodiment of the present disclosure.

FIG. 6 is a schematic diagram illustrating a microstructure of a manufactured light guide plate according to one embodiment of the present application.

### DETAILED DESCRIPTION OF PREFERRED EMBODIMENTS

To make the object, the technical solution and the advantages of the present disclosure clearer, the technical solution of the present disclosure will be described clearly and fully hereunder in combination with the specific embodiments and the corresponding drawings of the disclosure. Obviously, the described embodiments are merely part of the embodiments in the present disclosure rather than all the embodiments. Based on the embodiments of the present disclosure, all the other embodiments obtained by a person with ordinary skill in the art without making creative efforts pertain to the protection scope of the disclosure.

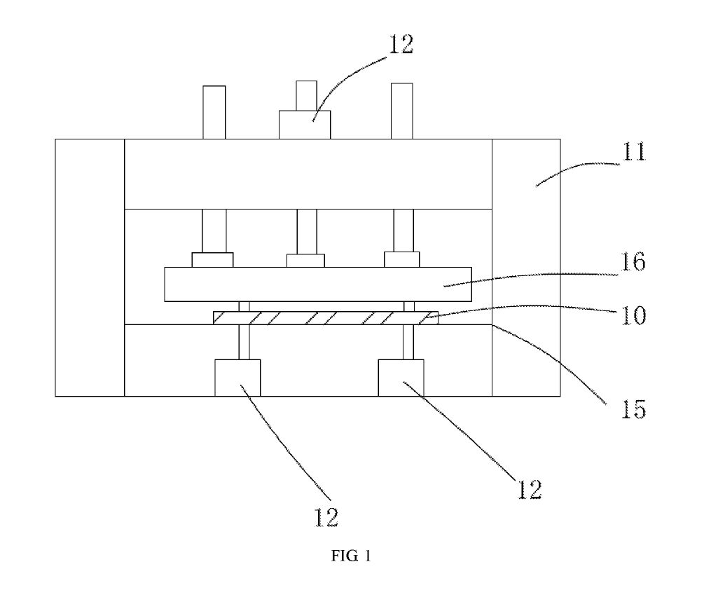

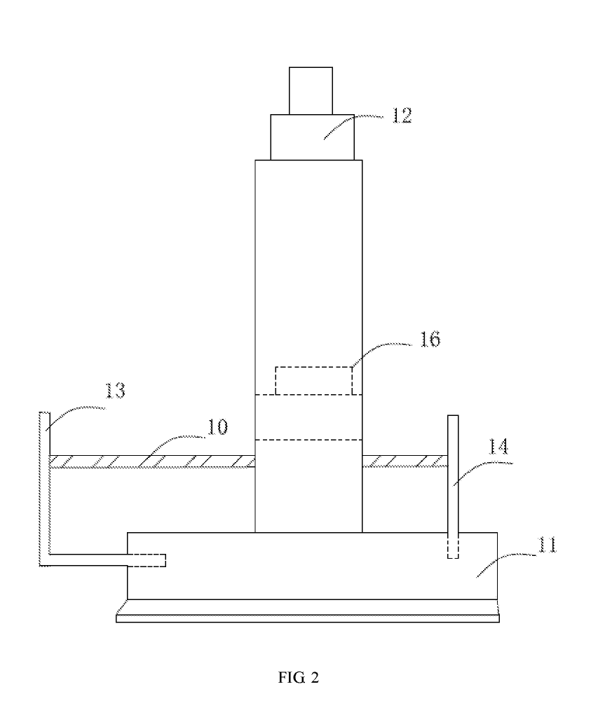

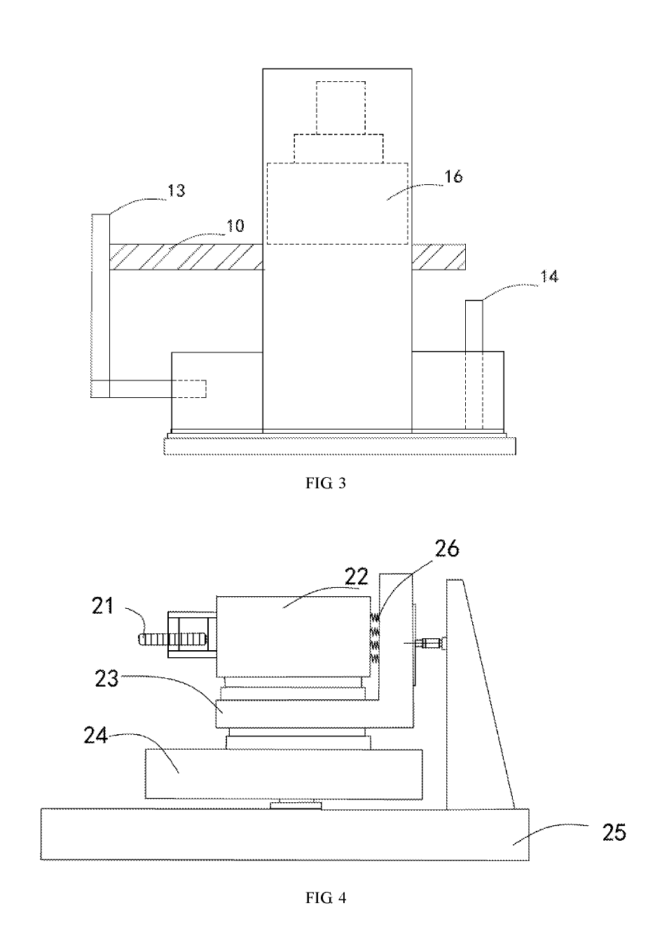

With reference to FIGS. 1 to 3, a surface machining device for a light guide plate according to the present disclosure is illustrated. The surface machining device may include: a support 11; driving component 12 mounted on the support 11; a push unit 13 driven by the driving component 12, configured to push the light guide plate 10 into a pre-set position; a positioning component 14 driven by the driving component 12, configured to position the light guide plate 10 at the pre-set position; a bearing component 15 mounted on the support 11, configured to bear the light guide plate 10; and a pressing component 16 driven by the driving component 12, configured to press the light guide plate 10 onto the bearing component 15.

The support 11 may be supported on ground, and configured to provide an overall framework of the surface machining device. Generally, the support 11 may be formed by several bearing columns standing on the ground and a beam born by the bearing columns. The support 11 may provide a carrying platform for other components of the surface machining device.

The driving component 12 may be configured to drive the configured components, to realize the feed and positioning of the light guide plate 10.

Further, in one embodiment, the driving component 12 may include a cylinder. A body of the cylinder 12 may be mounted on the support 11. A connecting rod of the cylinder may be movable relative to the body to provide power.

The push unit 13 may be configured to push the light guide plate 10 to a pre-set position. The push unit 13 may be driven by the driving component 12.

Further, in one embodiment, the push unit 13 may include a push rod assembly configured to push the light guide plate 10 to the pre-set position in a feed direction of the light guide plate 10. Generally, the push rod assembly may include a pair of vertical rods and a beam connected between the pair of rods. The beam may abut against the light guide plate 10, so as to push the light guide plate 10 to the pre-set position.

The positioning component 14 may be configured to position the light guide plate 10 at the pre-set position. The positioning component 14 may be driven by the driving component 12.

Further, in one embodiment, the positioning component 14 may be a positioning column.

The positioning column may abut against a surface to be machined of the light guide plate 10, when the positioning column is driven by the driving component 12 to be in a positioning state.

The positioning column may retreat to expose the surface to be machined of the light guide plate 10, when the positioning column is driven by the driving component 12 to be in a release state.

Similar to the aforementioned push unit 13, the positioning component 14 may be formed by a pair of vertical positioning columns and a beam connected between the pair of positioning columns.

The bearing component 15 may be mounted on the support 11, and configured to bear the light guide plate 10. The bearing component 15 may be generally a bearer formed by several rollers. The outer surface of the roller may be coated with a conveyor belt.

The pressing component 16 may be a planar pressing block, and driven by the driving component 12 to realize the pressing and releasing of the light guide plate 10.

Further, in one embodiment, the device may be further provided with a guide rail, so as to adjust the positioning component 14 to be parallel to the surface to be machined of the light guide plate 10, and to adjust the push unit 13 to be parallel to another surface of the light guide plate 10 opposite to the surface to be machined.

In the above-mentioned surface machining device, the light guide plate 10 may be adjusted to a proper position and then be clamped with the aid of the above-mentioned surface machining device, to facilitate the subsequent machining.

As illustrated in FIG. 4, another surface machining device for a light guide plate is provided, including:

a working head 21 configured to machine the surface of a light guide plate;

a clamping component 22 configured to clamp the working head 21;

a first horizontal seat 24 slidably connected to the clamping component 22 so as to allow the working head 21 to translate in a first direction; and

a second horizontal seat 25 slidably connected to the first horizontal seat 24 so as to allow the working head 21 to translate in a second direction perpendicular to the first direction.

The working head 21 may be configured to machine the surface of the light guide plate 10. In this embodiment, the working head 21 may be a toothed wheel.

Further, in one embodiment, the surface machining device may be further provided with a temperature control assembly configured to heat the working head 21. The temperature control assembly may include a heating rod, a temperature sensor, and a chip or a microcontroller configured to control operation of the heating rod and the temperature sensor.

The clamping component 22 may be configured to clamp the working head 21 so as to drive the working head 21 to machine the surface of the light guide plate 10 at a proper position. In this embodiment, the clamping component 22 may be a slider provided with a shaft. The working head 21 may be rotatably mounted on the shaft.

The first horizontal seat 24 may be slidably connected to the clamping component 22 so as to allow the working head 21 translate in a first direction.

The first horizontal seat 24 may be a table top. A slide rail may be provided between the first horizontal seat 24 and the clamping component 22.

Further, in one embodiment, a clamping seat 23 is provided between the clamping component 22 and the first horizontal seat 24.

The clamping component 22 may be translatable in the first direction with respect to the clamping seat 23;

The clamping seat 23 may be translatable in the first direction with respect to the first horizontal seat.

Similarly, a slide rail may be further provided between the clamping seat 23 and the clamping component, and a slide rail may be further provided between the clamping seat 23 and the first horizontal seat 24. In this way, the clamping component 22 may be translatable in the first direction with respect to the clamping seat 23, and the clamping seat 23 may be translatable in the first direction with respect to the first horizontal seat 24. Moreover, the efficiency of machining the light guide plate 10 by the working head 21 can be improved by configuring an appropriate travel of the slide rail. For example, the sliding travel of the clamping seat 23 with respect to the first horizontal seat 24 may be 1 m, and the sliding travel of the clamping component 22 with respect to the clamping seat 23 may be 10 cm.

Further, in one embodiment, an elastic element 26 may be provided between the clamping component 22 and the clamping seat 23, to provide a pre-set machining pressure during machining of the surface of the light guide plate 10.

In this embodiment, the elastic element 26 may be a spring. During the machining, the pre-set machining pressure for the light guide plate 10 may be maintained by the elastic force of the elastic element 26. In this wat, the machining pressure is nether too large to cause deformation of the light guide plate 10, nor too little to cause insufficient machining of the light guide plate 10.

The second horizontal seat 25 may be slidably connected to the first horizontal seat 24 so as to allow the working head 21 translate in a second direction perpendicular to the first direction.

Further, in one embodiment, the clamping seat 23 may be translatable in the second direction with respect to the second horizontal seat 25.

Similarly, a slide rail may be provided between the first horizontal seat 24 and the second horizontal seat 25. For example, the first horizontal seat 24 may move in a horizontal forward and backward direction relative to the second horizontal seat 25. The clamping seat 23 may move in a horizontal left and right direction relative to the first horizontal seat 24.

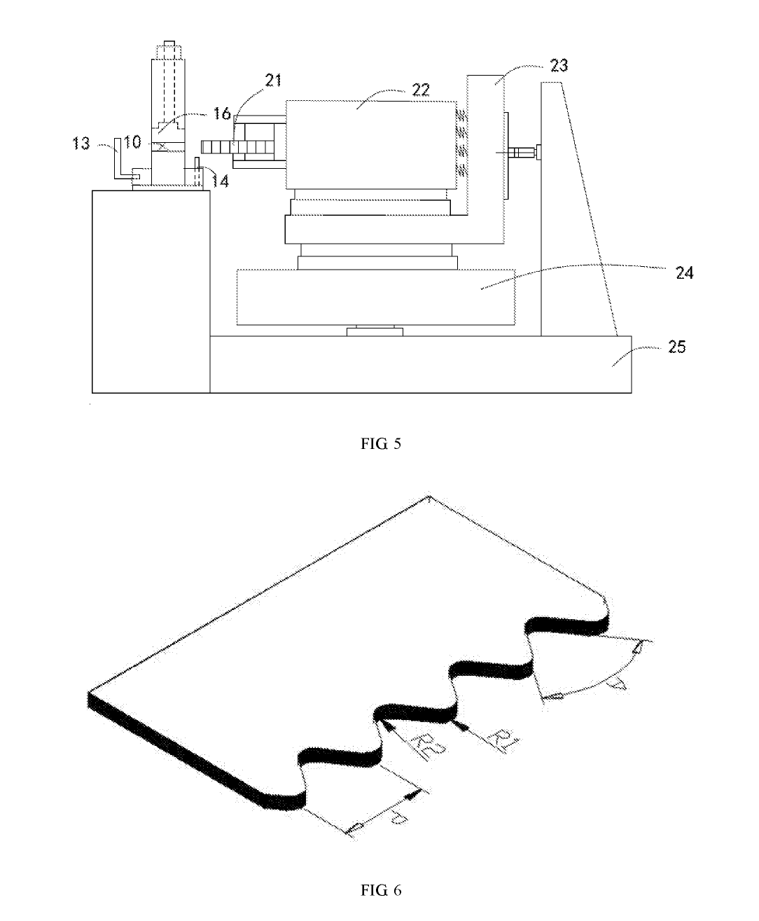

FIG. 5 illustrates two cooperated surface machining devices according to the present disclosure that machine a surface of a light guide plate 10.

With reference to FIG. 6, a light guide plate 10 manufactured by the above-mentioned positioning device and machining device will be described below.

At least one surface of the light guide plate 10 may formed with a plurality of serrated grooves. Each serrate groove has an opening angle of 40° to 119°. There may be a transition fillet R1 between adjacent two serrated grooves, with a radius in a range between 6 μm and 38 μm. There may be a transition fillet R2 arranged at the bottom of each serrated groove, with a radius in a range between 1 μm and 38 μm. Each serrated groove may have a span in a range between 20 μm and 300 μm.

An application scenario for implementing the present disclosure is described below:

The light guide plate 10 may be placed onto the bearing component 15 of the surface machining device for positioning. The push unit 13 and the positioning component 14 may be adjusted so that the push unit 13 is parallel to an surface not to be machined of the light guide plate 10, and the positioning component 14 is parallel to the surface to be machined of the light guide plate 10. The driving component 12 may be controlled to drive the positioning component 14 to the pre-set position. The driving component 12 may be controlled to drive the push unit 13 to push the light guide plate 10 to be fed to the pre-set position. Then, the driving component 12 may be controlled to drive the pressing component 16 to press the light guide plate 10 onto the bearing component 15. Then, the driving component 12 may be controlled to drive the positioning component 14 to retreat to expose the surface to be machined of the light guide plate 10. With this, the positioning process of the light guide plate 10 may be completed.

The working head 21 may be clamped by the clamping component 22. The clamping component 22 may be driven to slide along the first direction with respect to the clamping seat 23, the clamping seat 23 may be driven to slide along the first direction with respect to the first horizontal seat 24, and the first horizontal seat 24 may be driven to slide along the second direction with respect to the second horizontal seat 25, to adjust the distance between the working head 21 and the surface to be machined of the light guide plate 10. Meanwhile, the working head 21 may be heated with the temperature control assembly to a pre-set temperature, for example, 60° C. to 200° C. Then, the working head 21 may be adjusted to press the surface to be machined of the light guide plate 10, and machine the light guide plate 10, to form a desirable microstructure on the surface of the light guide plate 10. At least one surface of the light guide plate 10 may be formed with a plurality of serrated grooves. Each serrate groove has an opening angle of 40° to 119°. There may be a transition fillet between adjacent two serrated grooves, with a radius in a range between 6 μm and 38 μm. There may be a transition fillet arranged at the bottom of each serrated groove, with a radius in a range between 1 μm and 38 μm. Each serrated groove may span a distance in a range between 20 μm and 300 μm.

The above embodiments are chosen and described in order to explain the principles of the disclosure and their practical application so as to activate others skilled in the art to utilize the disclosure. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. An surface machining device for a light guide plate, comprising:
a support;
a driving component mounted on the support;
a push unit driven by the driving component, configured to push the light guide plate to a pre-set position;
a positioning component driven by the driving component, configured to position the light guide plate at the pre-set position;
a bearing component mounted on the support, configured to bear the light guide plate; and
a pressing component driven by the driving component, configured to press the light guide plate onto the bearing component.

2. The surface machining device of claim 1, wherein the driving component includes a cylinder.

3. The surface machining device of claim 1, wherein the push unit includes a push rod assembly configured to push the light guide plate to the pre-set position in a feed direction of the light guide plate.

4. The surface machining device of claim 1, wherein the positioning component includes a positioning column;
wherein the positioning column is adapted to abut against a surface to be machined of the light guide plate, when the positioning column is in a positioning state driven by the driving component; and
wherein the positioning column is adapted to retreat to expose the surface to be machined of the light guide plate, when the positioning column is in a release state driven by the driving component.

5. The surface machining device of claim 1, further comprising a guide rail, so as to adjust the positioning component to be parallel to the surface to be machined of the light guide plate, and to adjust the push unit to be parallel to another surface of the light guide plate opposite to the surface to be machined.

6. An surface machining device for a light guide plate, comprising:
a working head configured to machine a surface of the light guide plate;
a clamping component configured to clamp the working head;
a first horizontal seat slidably connected to the clamping component to allow the working head to translate in a first direction; and
a second horizontal seat slidably connected to the first horizontal seat to allow the working head to translate in a second direction perpendicular to the first direction.

7. The surface machining device of claim 6, wherein a clamping seat is provided between the clamping component and the first horizontal seat;
the clamping component is translatable in the first direction with respect to the clamping seat; and
the clamping seat is translatable in the first direction with respect to the first horizontal seat.

8. The surface machining device of claim 7, wherein an elastic element is provided between the clamping component and the clamping seat, to provide a pre-set machining pressure during machining for the surface of the light guide plate.

9. The surface machining device of claim 7, wherein the clamping seat is translatable in the second direction with respect to the second horizontal seat.

10. The surface machining device of claim 6, further comprising a temperature control assembly configured to heat the working head.

11-15. (canceled)

16. An surface machining system for a light guide plate, comprising:
a first surface machining device, including:
a support;
a driving component mounted on the support;
a push unit driven by the driving component, configured to push the light guide plate to a pre-set position;
a positioning component driven by the driving component, configured to position the light guide plate at the pre-set position;
a bearing component mounted on the support, configured to bear the light guide plate; and
a pressing component driven by the driving component, configured to press the light guide plate onto the bearing component; and
a second surface machining device cooperated with the first surface machining device, including:
a working head configured to machine a surface of the light guide plate;
a clamping component configured to clamp the working head;
a first horizontal seat slidably connected to the clamping component to allow the working head to translate in a first direction; and
a second horizontal seat slidably connected to the first horizontal seat to allow the working head to translate in a second direction perpendicular to the first direction.

17. (canceled)

18. A light guide plate, comprising at least one surface formed with a plurality of serrated grooves, each serrate groove having an opening angle of 40° to 119°.

19. The light guide plate of claim 18, wherein a transition fillet is arranged between adjacent two serrated grooves, with a radius in a range between 6 μm and 38 μm.

20. The light guide plate of claim 19, wherein a transition fillet is arranged at the bottom of each serrated groove, with a radius in a range between 1 μm and 38 μm.

21. The light guide plate of claim 20, wherein each serrated groove spans a distance in a range between 20 μm and 300 μm.

22. A surface machining method for a light guide plate, using a surface machining system to machine a surface to be machined of the light guide plate, the surface machining system comprising a first surface machining device and a second surface machining device cooperated with the first machining device,
the first surface machining device, including:
a support;
a driving component mounted on the support;
a push unit driven by the driving component, configured to push the light guide plate to a pre-set position;
a positioning component driven by the driving component, configured to position the light guide plate at the pre-set position;
a bearing component mounted on the support, configured to bear the light guide plate; and
a pressing component driven by the driving component, configured to press the light guide plate onto the bearing component; and
the second surface machining device, including:
a working head configured to machine the surface to be machined of the light guide plate;
a clamping component configured to clamp the working head;
a first horizontal seat slidably connected to the clamping component to allow the working head to translate in a first direction; and
a second horizontal seat slidably connected to the first horizontal seat to allow the working head to translate in a second direction perpendicular to the first direction;
the surface machining method comprising:
placing the light guide plate onto the bearing component;
adjusting the positioning component, so that the positioning component is parallel to the surface to be machined of the light guide plate;
controlling the positioning component and the push unit, so that the light guide plate is fed to the pre-set position;
adjusting the working head by the first horizontal seat and the second horizontal seat, so that the working head and the surface to be machined of the light guide plate are faced to each other with a pre-set distance; and
adjusting the working head to press the surface to be machined of the light guide plate to machine the surface to be machined, so that the machined surface being formed with a plurality of serrated grooves, each serrate groove having an opening angle of 40° to 119°.

23. The surface machining method of claim 22, wherein the working head is adjust to press the surface to be machined of the light guide plate to machine the surface to be machined, so that a transition fillet is arranged between two adjacent serrated grooves, with a radius in a range between 6 μm and 38 μm.

24. The surface machining method claim 23, wherein the working head is adjust to press the surface to be machined of the light guide plate to machine the surface to be machined, so that a transition fillet is arranged at the bottom of each serrated groove, with a radius in a range between 1 μm and 38 μm.

25. The surface machining method of claim 24, wherein the working head is adjust to press the surface to be machined of the light guide plate to machine the surface to be machined, so that each serrated groove spans a distance in a range between 20 μm and 300 μm.

26. A surface machining method for a light guide plate, using a surface machining system to machine a surface to be machined of the light guide plate, the method comprising:
pushing the light guide plate to a pre-set position;
adjusting the light guide plate, so that a working head of the surface machining system and the surface to be machined of the light guide plate are faced to each other with a pre-set distance; and
adjusting the working head to press the surface to be machined of the light guide plate to machine the surface to be machined, so that the machined surface being formed with a plurality of serrated grooves, each serrate groove having an opening angle of 40° to 119°.

27. The surface machining method of claim 26, wherein the working head is adjust to press the surface to be machined of the light guide plate to machine the surface to be machined, so that a transition fillet is arranged between two adjacent serrated grooves, with a radius in a range between 6 μm and 38 μm.

28. The surface machining method claim 27, wherein the working head is adjust to press the surface to be machined of the light guide plate to machine the surface to be machined, so that a transition fillet is arranged at the bottom of each serrated groove, with a radius in a range between 1 μm and 38 μm.

29. The surface machining method of claim 28, wherein the working head is adjust to press the surface to be machined of the light guide plate to machine the surface to be machined, so that each serrated groove spans a distance in a range between 20 μm and 300 μm.
